(19) United States
(12) Patent Application Publication
(10) Pub. No.: US 2010/0023720 A1
(43) Pub. Date: Jan. 28, 2010

(54) METHOD AND APPARATUS FOR RECOGNIZING CHANGES TO DATA

(76) Inventor: Ingo Skuras, Muenchen (DE)

Correspondence Address: MICHAEL BEST & FRIEDRICH LLP, 100 E WISCONSIN AVENUE, Suite 3300, MILWAUKEE, WI, 53202, US

(21) Appl. No.: 12/510,295

(22) Filed: Jul. 28, 2009

(30) Foreign Application Priority Data
Jul. 28, 2008 (DE) 10 2008 035 095.8

(51) Int. Cl. G06F 12/00; G06F 21/00

(52) U.S. Cl. 711/163; 726/26; 711/E12.001

(57) ABSTRACT

The present invention refers to a method and apparatus, in which changes to relevant data are made easily recognizable. The data is stored in the same sector of a flash memory as a program which is used for the start-up or operation of a device. Due to the characteristics of flash memory the complete sector including the program is deleted when deleting the relevant data, by which the device is no longer operable and a malfunction and damage can be avoided. Furthermore, a bitwise inverted form of the data is stored in the flash memory, and it is inspected whether the original and the inverted form of the data coincide. A change to the data, which is not recognizable by the inspection, requires the deletion of the sector, thereby also deleting the program and thus the device is no longer operable.

### FIELD OF THE INVENTION

The present invention relates to a method and an apparatus for storing data to be protected, so that changes to the data can be recognized. In particular, the present invention relates to an apparatus, which can be implemented in a plurality of different domains.

### BACKGROUND OF THE INVENTION

None-volatile memory mediums are commonly used to store important information, such as starting procedures or configuration files of a system. A BIOS program is indispensible for starting a computer, and was thus filed for a long time during production on a ROM memory (Read Only Memory). The BIOS program can no longer be changed then, except by exchanging the complete ROM memory for a new ROM memory with an updated BIOS program.

An apparatus, such as a telematic unit, can have several standard configurations, that allow different memory configurations or different input/output capabilities. These standard configurations are necessary for the apparatus to function flawlessly and are not allowed to be changed.

Of course, the standard configuration must be located on the one hand on a non-volatile storing medium, so that they are not lost when switching off or during any other power interruption of the telematic apparatus. On the other hand, it must be made sure that this configuration data is not (un)intentionally deleted or changed and thus does not lead to a malfunction of the apparatus.

There exist various mechanisms and provisions to protect data on a storing medium. For instance, there is the possibility for flash memory to allow a writing access only, if a high voltage, for example 12 Volt for a 5 Volt flash memory, is input to a corresponding pin of the flash memory. Thus, data on the flash memory can only be changed or deleted when such a voltage is applied. In some systems such voltages in the order of 12 Volt cannot be reached however; thus, this safety provision of the flash memory can only be applied conditionally. Moreover, an additional pin is necessary at the apparatus.

Furthermore, particular pins in the flash memory can be provided, which must be bridged with a jumper to allow a writing access. The physical moving of a jumper for each writing access on a memory can be very cumbersome, in particular if the flash memory and thus the pins with the jumper are difficult to access.

To avoid changes to the data due to a software error, writing routines can be implemented, which start with a complicated instruction sequence. Such complex instruction sequences are not generated accidentally through unintentional electric or programmatic actions.

A further alternative would be to have the data on a ROM storing medium, whose content cannot be changed. Though unintentional changes to the stored data can be excluded, this variant, however, also greatly limits the use and possible intentional changes to the data.

Similarly, a particular configuration can be hard coded using SMD (Surface Mounted Device) resistors. Also in this case an intentional change of the configuration is not easily possible.

### SUMMARY OF THE INVENTION

The object of present invention consists of providing a method to protect data from being changed or deleted. Furthermore, a change to the data should be easily recognized. The inventive method and the corresponding apparatus do not possess the above problems and disadvantages of the prior art.

One fundamental idea of the present invention consists of exploiting one disadvantage of flash memories in order to protect particular data on a flash memory from changes or deletion. Though the actual process of changing or deletion is not prevented or limited, a change or deletion of the data to be protected is on the one hand easy to recognize according to the invention. On the other hand, the present invention impedes that an apparatus, which uses the changed or deleted data, can be operated further.

The disadvantage of flash memories, which here is taken advantage of by the invention, relates to the fact that a flash memory can be coded bit by bit, however, only complete sectors can be reset/deleted. The data to be protected, be it configuration data or other data to be protected, is used by the apparatus. A program important to the apparatus is also stored in the flash memory. According to the present invention, the data to be protected is written on the same memory sector as at least one part of the program, wherein said part of the program should be indispensible for the correct execution of the program.

If the data to be protected is deleted, one part of the program is deleted as well, since only the complete flash sector can be deleted. Thus, the program can no longer be executed, and malfunctions of the apparatus due to the deletion of the data are avoided. It is apparent for a skilled person that there are various different data, that, when deleted, the associated apparatus should not be able to operate any longer. The examples given here for such data are not be construed as limiting; there are too many possibilities for such data to be protected, to be all included in this description.

A further fundamental idea of the invention is directed to write the data to be protected two times into the flash memory, wherein the data to be protected is stored once in a form, which is inverted bit by bit. In general, the data to be protected, being the not inverted or the inverted data, cannot be changed, such that both data continue to be consistent. It is, thus, easy to verify, whether the data to be protected is still correct and can be used by a corresponding program as intended, without producing errors.

The only possibility to amend both versions of the data to be protected so that a correspondence is still maintained, is to delete one of the two versions and to write it anew so that this corresponds to the changed other version of the data to be protected.

However, if both fundamental ideas of the invention are combined, both data can neither be deleted nor changed without making unusable the program that uses these data. Respectively one part of the program, that uses the data, is stored in the same memory sector as the two versions of the data to be protected. If one version of the data is deleted, so as to write it anew according to a change to the other version, said part of the program in the same sector is deleted too. Thus, there is no possibility to change or delete the data to be protected without recognizing this, or without rendering unusable the program that accesses this data.

The advantages that result from the inventive storing of the data to be protected are manifold. On the one hand, there is no special hardware necessary to protect the data; the actual storing takes place with already existing hardware. Since there are almost no restrictive requirements to the data, to the apparatus or to the program, the invention can be applied to a great deal of different areas and situations.

According to an embodiment of the invention, a method is provided for storing data to be protected on a flash memory. The flash memory is divided into a plurality of memory sectors and is destined for an apparatus, which needs a program routine for its start and/or operation. The data to be protected is stored in the same memory sector, in which at least one part of the program routine is stored.

Thus, though the data to be protected is not protected from being (un)intentionally deleted, the program and thus the apparatus are not operable.

According to an advantageous embodiment of the invention, the flash memory is of the NOR memory type.

According to a further embodiment of the invention, the program routine is a writing routine to write the flash memory, or is a boot loader. Furthermore, the program routine should need to use the data to be protected.

According to a further advantageous embodiment, the data to be protected is also stored in the flash memory in a bitwise-inverted form. Thus, the original data can be verified for changes bit by bit.

An additional embodiment of the invention stores the bitwise-inverted form of the data to be protected in a further memory sector of the flash memory, and furthermore, one further part of the program routine can also be stored in the further memory sector.

Advantageously, the data to be protected in the memory sector is checked for correspondence with the bitwise-inverted form of the data to be protected.

According to an embodiment of the invention, an apparatus is provided storing data to be protected in a flash memory, wherein the apparatus needs a program routine for its start and/or operation. The flash memory, which is divided into a plurality of memory sectors, stores the data to be protected in the same memory sector, in which at least one part of the program routine is stored.

According to an embodiment of the invention, also a storing medium is provided with instructions for storing data to be protected on a flash memory, which is divided into a plurality of memory sectors and which is destined for an apparatus, which needs a program routine for its start and/or operation. The data to be protected is stored in the same memory sector, in which at least one part of the program routine is stored.

### BRIEF DESCRIPTION OF THE DRAWINGS

Embodiments of the present invention are described in more detail in the following using the figures.

FIG. 1 shows a schematic representation of a flash memory, according to a configuration of one embodiment of the invention, in which a program and the relevant data is stored in the same memory sector;

FIG. 2 shows a comparison of an original and inverted form of data;

FIG. 3 shows a schematic representation of a flash memory, according to the configuration of a further embodiment of the invention, in which, respectively, an original and an inverted form of the data to be protected is stored together with one part of the program in a memory sector; and

FIG. 4 shows the comparison of FIG. 2, in which two bits are changed from “1” to “0”.

### DETAILED DESCRIPTION

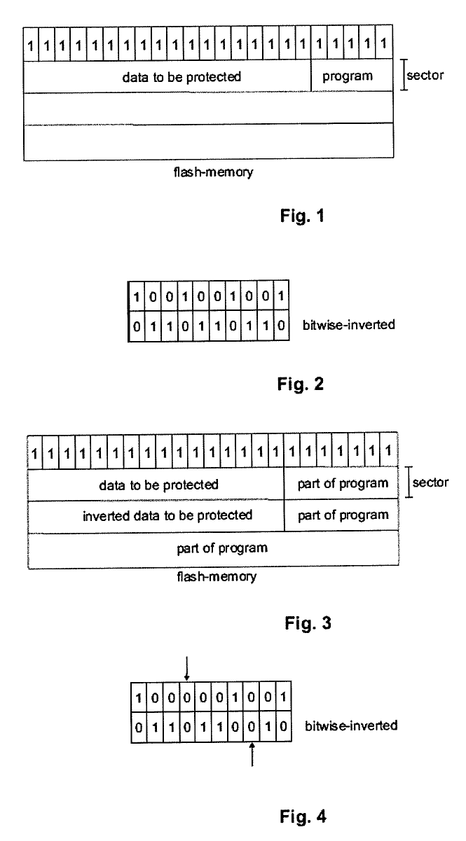

The inventive method is to be described in detail in the following with reference to the FIGS. 1 to 4.

In the following, some embodiments are described in more detail, which are not to be construed as limiting, but are only to be understood as advantageous embodiments of the invention. A skilled person is capable to infer further obvious embodiments from the description, which cannot be described explicitly because of the great number of possibilities.

The flash memory, as it is exemplarily and schematically illustrated in FIG. 1, is composed of a particular number of single storing elements, which depend on the memory size. The bytes and words (typically up to 64 bit) can be addressed singularly. Thereby, these can be written individually in some architectures, whereas with others only greater amounts of data can be programmed at a time. Normally, the contrary operation, the deletion is only possible in greater units, so called sectors (mostly a quarter, eighth, sixteenth part, etc. of the total storage capacity). Normally, this is the case for flash memories of the NOR type. However, the logical polarity is not always the same: there exist implementations, where the programming is put into practice as a logical transition from “0” to “1”, as well as the other way round.

A common feature, however, is always that both operations

respectively only represent the transition in one direction (“0” to “1” or “1” to “0”), and

only one of both can work bit selective: the programming.

That means, with flash memories always a deletion operation of a sector is necessary for rewriting, so as to create the desired bit sequence, i.e. the desired memory content, through programming operations.

The exemplary flash memory of FIG. 1 possesses four sectors and, furthermore, it is assumed that “1” is the initial state and “0” is the final state of one bit. Thus, the first sector of the depicted flash memory would be totally empty.

According to an embodiment of the invention, the data to be protected is written into the same sector as a program, which is indispensible for the functioning of an apparatus, which is equipped with the flash memory. However, not the complete program has to be in the same sector as the relevant data, but it suffices that only a part of the program is stored in the same sector, wherein the program cannot function without said part.

Said program can be for example a boot loader, and the relevant data to be protected is BIOS data for booting up a computer correctly. If the boot loader is deleted together with the BIOS data, or made inoperable, then the computer cannot be started any more, and malfunctions due to the missing or wrong BIOS data can thus be avoided. Making the computer inoperable, can already be advantageous, if for example an intruder changes the BIOS data, so as to do further damage with the computer.

The program can also be a writing routine of the apparatus. If said instruction sequence, which is basic for a memory, is deleted or made inoperable, the apparatus can no longer be operated. Also in this case it is avoided that during a further operation with missing or wrong data, errors can appear (un)intentionally and lead to damages.

The above programs are only to be examples. It is easily understood by a skilled person that also other programs can be applied according to the idea of the invention. What is mainly important is that the deletion (or at least making these programs inoperable), has the consequence for the apparatus that the actual operation of the apparatus is no longer possible and/or that the apparatus is switched off completely, or is brought into a secure state. Thus, no more malfunctions and damages can be generated at the apparatus, and also as unauthorized user can no longer use the apparatus.

There are no restrictions to be made for the apparatus too. For instance, the apparatus can be a computer, which possesses a flash memory on the main board, wherein standard BIOS data is stored on the flash memory during the manufacturing, which can under no circumstances be changed or deleted, since otherwise a safe starting procedure is not ensured. Thereby, such changes can be unintentionally or be intentionally by an intruder. It is also possible that malware, such as a virus, is capable of changing the BIOS of a computer system purposefully. Because of the deficient configuration data of the BIOS, malfunctions and damages can thus appear at the components of the computer system.

Another example for an apparatus is a telematic apparatus, which can possess various different standard configurations, which differ from one another, e.g. in the respective memory configurations or input/output settings. These different configuration data should be for example stored during a final test phase in such a way that the apparatus does not work with possibly corrupt or deleted configuration data, so as to avoid errors and damages.

Depending on which apparatus the invention should be implemented in, the data and also the program that come into consideration may differ.

The skilled person is capable of adapting the exemplary embodiments of the invention that are described here to other requirements of other areas.

According to a further embodiment, the data to be protected is written into the flash memory two times, so as to also make changes to the data immediately recognizable. Namely, the data is additionally stored in an inverted form. FIG. 2 compares the normal and inverted form of the data for some bits. In fact, it is the same data, but one version is inverted. Therefore, the data correspond with one another, since they are exactly converse, and it is easy to verify, whether the relevant data still correspond or have been changed.

In combination with the previous embodiment, in which the data is stored together with a program or part of the program within the same memory sector, a memory configuration as depicted in FIG. 3 is achieved. The first sector is again empty, since all bits possess the value “1”. The second memory sector of the flash memory comprises the relevant data and a part of the program. The third sector comprises a bitwise-inverted form of the data to be protected and a further part of the program. In the exemplary embodiment of FIG. 3 the remaining program is stored in the last memory sector. In the exemplary embodiment it is assumed that the inverted form of the data is stored in another memory sector as the not inverted form of the data to be protected. This is, however, not absolutely necessary; it would also be possible to store the inverted and original form of the data at different addresses of the same memory sector. For the further discussion, it is assumed for purposes of simplification that the configuration according to FIG. 3 is used.

A checking routine can check both forms of the data for correspondence, wherein the checking routine for example can be started regularly or only, respectively before using said data. In doing so, it is verified that the data has not been changed by either inverting the inverted data again, or inverting the original data, so as to obtain the same form of the original data.

As will be shown in the following, a change of the data is not possible without making such a change easily recognizable.

According to the property of a flash memory, single bits can be changed only from “1” to “0”, assuming that the initial state is “1” and the final state is “0”, as already discussed above. Compared to the bit sequence of FIG. 2, the bit sequence according to FIG. 4 has been changed at two bits to “0”, respectively one in the original and in the inverted data, as denoted by the arrows. Such a change is immediately recognizable by comparing the data.

The only possibility to change both data such that they correspond to one another, is for example to change the first data and to at first delete the memory sector of the other data, and then, according to the changed data in the first sector, to rewrite the memory sector with corresponding inverted data anew. In other words, one memory sector would have to be always deleted to allow the adaptation of the other data, when changing one of the both data, so that these changes would not be recognized by a checking routine. This is a direct consequence of the properties of flash memories.

However, since a part of the program has been also stored in the memory sectors, when deleting the sectors this part of the program would be deleted as well, wherein the program and, thus, the apparatus would no longer be operable.

In performing the storage of relevant data as just described, an unrecognized change of data is not possible. Either the checking routine recognizes a difference between the original and the inverted form of the data. Or the program, that is stored in the same memory sector, is no longer operable, since such a data change, that would not be recognized by the checking routine, necessitates a deletion of the sector, in which at least a part of the program is located.

Thus, relevant data can be stored in a flash memory in such a way that a change of the data is easily recognizable. Furthermore, it is advantageous that no additional hardware is necessary or already existing hardware does not need to be adapted to allow this form of recognizing. As already hinted at, the way of protecting the data according to the invention is very flexible and can be adapted to various different products and configurations.

What is claimed is:

1. Method for storing data to be protected on a flash memory, wherein the flash memory is divided into a plurality of memory sectors and is destined for an apparatus, which needs a program routine for its start and/or operation, wherein the method comprises the step of:
storing the data to be protected in the same memory sector, in which at least one part of the program routine is stored.

2. Method according to claim 1, wherein the flash memory is flash memory of a NOR type.

3. Method according to claim 1, wherein the program routine is a writing routine for writing on the flash memory.

4. Method according to claim 1, wherein the program routine is a boot loader.

5. Method according to claim 1, wherein the program routine uses the data to be protected.

6. Method according to claim 1, wherein the apparatus is a telematic apparatus.

7. Method according to claim 1, further comprising the step of:
storing the data to be protected in the flash memory in a bitwise-inverted form.

8. Method according to claim 7, wherein the bitwise-inverted form of the data to be protected is stored in a further memory sector of the flash memory.

9. Method according to claim 8, wherein a second part of the program routine is stored together with the bitwise-inverted form of the data to be protected in the further memory sector.

10. Method according to claim 7 further comprising the step of:
verifying whether the data to be protected in the memory sector corresponds to the bitwise-inverted form of the data to be protected.

11. Method according to claim 10, wherein the step of verifying comprises:
inverting the data to be protected in the memory sector, and comparing the inverted data to be protected of the memory sector with the bitwise-inverted form of the data to be protected of the further memory sector, or
inverting the bitwise-inverted form of the data to be protected of the further memory sector, and comparing the two times inverted data to be protected of the further memory sector with the data to be protected of the memory sector.

12. Method according to claim 1, wherein one single bit of the memory sector of the flash memory can be changed from a first value, which is 1 or 0, to a final value, which is 0 or 1, by only changing said single bit, and
wherein a single bit of a memory sector of the flash memory can be changed from the final value to the first value only by changing all bits of a memory sector to the first value.

13. Apparatus for storing data to be protected in a flash memory, wherein the apparatus needs a program routine for its start and/or operation, comprising:
flash memory, which is divided into a plurality of memory sectors, for storing the data to be protected in the same memory sector, in which at least one part of the program routine is stored.

14. Apparatus according to claim 13, wherein the program routine uses this data.

15. Apparatus according to claim 13, wherein the data to be protected is additionally stored in the flash memory in a bitwise-form.

16. Apparatus according to claim 15, wherein the bitwise-inverted form of the data to be protected is stored in a further memory sector of the flash memory.

17. Apparatus according to claim 16, further comprising:
a processing unit to verify whether the data to be protected in the memory sector corresponds to the bitwise-inverted form of the data to be protected in the further memory sector.

18. Apparatus according to claim 13, wherein the apparatus is a telematic apparatus.

19. Storing medium for carrying instructions to store data to be protected on a flash memory, which is divided into a plurality of memory sectors and is destined for an apparatus, which needs a program routine for its start and/or operation, wherein one instruction prompts:
storing the data to be protected in the same memory sector, in which at least one part of the program routine is stored.
